(19) United States
(12) Patent Application Publication
(10) Pub. No.: US 2025/0248332 A1
(43) Pub. Date: Aug. 7, 2025

(54) Detecting Multiple Specific Issues From A Single User Input

(71) Applicant: DEERE & COMPANY, Moline, IL (US)

(72) Inventors: Jeremiah K. Johnson, Williamsburg, IA (US); Adam J. Donohoe, West Branch, IA (US); Matthew T. Wold, Coal Valley, IL (US); Nicholas W. Meyer, Waukee, IA (US); Nicholas M. Cain, Eldridge, IA (US)

(21) Appl. No.: 18/433,671

(22) Filed: Feb. 6, 2024

(51) Int. Cl. A01D 41/127; G06T 7/00

(52) U.S. Cl. CPC A01D 41/127; G06T 7/0002; G06T 2207/30188

(57) ABSTRACT

An agricultural machine includes a chassis and a header coupled to the chassis. The header is configured to harvest crop in a field. A grain tank is coupled to the agricultural machine and configured to collect grain from the harvested crop. A separating section of the agricultural machine is configured to separate grain from the harvested crop. A cleaning shoe of the agricultural machine is configured to clean grain from the separating section and move clean grain towards the grain tank, wherein the separating section and cleaning shoe are positioned between the header and the grain tank. The agricultural machine further includes a plurality of sensors configured to detect one or more of grain loss from the agricultural machine or grain quality; and includes three user inputs setting threshold values for grain loss and grain quality.

### FIELD OF THE DISCLOSURE

The present disclosure generally relates to agricultural machines, and, more specifically, to systems and methods for reducing user inputs for agricultural machine automation.

### BACKGROUND

Agricultural machines, such as combines, harvest crop in a field. Many functions of agricultural machines are performed via automation. Some settings in agricultural machine may be adjusted via automation, and adjusting one or more settings may adjust job outcomes or functions. Generally, to adjust the job outcomes or functions of an agricultural machine an operator adjusts multiple settings or acceptability parameters.

### SUMMARY

According to one implementation of the present disclosure, an agricultural machine configured to perform a harvesting operation includes a chassis; a header coupled to the chassis, the header configured to harvest a crop during the harvesting operation in a field; a separating section of the agricultural machine configured to separate grain from the harvested crop; a cleaning shoe of the agricultural machine configured to clean the grain received from the separating section and move the grain towards a tank coupled to the chassis, wherein the separating section and cleaning shoe are positioned downstream from the header and upstream from the tank; a sensor configured to detect a quantity of grain loss from the agricultural machine during the harvesting operation or a quality of the grain; a control system comprising a controller disposed in communication with the sensor, the controller configured to store a first threshold related to a quantity of grain loss and a second threshold related to a grain quality; wherein the controller is configured to receive a signal from the sensor, the signal corresponding to the quantity of grain loss or the quality of the grain; wherein the controller is configured to compare the signal from the sensor to either the first threshold or the second threshold and determine if the quantity of grain loss exceeds the first threshold in response to the comparison of the signal from the sensor to the first threshold or the quality of the grain exceeds the second threshold in response to the comparison of the signal from the sensor to the second threshold.

In some examples, the sensor comprises a plurality of sensors, wherein one of the plurality of sensors detects the quantity of grain loss from the separating section, the cleaning shoe, or the header. According to some examples, the sensor comprises a plurality of sensors, where one of the plurality of sensors detects the quality of the grain in a tank or an elevator coupled to the chassis. In some implementations, the sensor comprises a camera. In some examples, the sensor is configured to capture an image of the grain when detecting the quality of the grain, the controller receiving the image from the sensor via the signal and being configured to analyze the quality of the grain from the image. According to an example, the controller is configured to adjust a machine setting in response to the grain loss exceeding the first threshold or in response to the quality of the grain exceeding the second threshold.

In some examples, the sensor is configured to detect the quantity of grain loss, the quality of the grain, or a quantity of broken grain during the harvesting operation; the controller is configured to store a third threshold related to broken grain; and wherein, when the sensor detects the quantity of broken grain during the harvesting operation, the sensor is configured to communicate the signal corresponding to the quantity of broken grain to the controller, and the controller is configured to compare the quantity of broken grain to the third threshold. According to some implementations, the machine setting includes one or more of rotor speed, threshing clearance, fan speed, chaffer clearance, and sieve clearance. According to an example, the controller comprises a plurality of controllers, where a first controller of the plurality of controllers is in communication with the sensor and is configured to receive the signal from the sensor and compare the signal from the sensor to the first threshold or second threshold; wherein a second controller of the plurality of controllers is communicatively coupled to the first controller, the second controller configured to adjust one or more machine settings based on the comparison of the signal to the first threshold or second threshold.

In some implementations, the machine setting comprises at least a first machine setting and a second machine setting; after the controller adjusts the first machine setting, the controller is configured to detect the quantity of grain loss or quality of grain, and if the controller determines that the quantity of grain loss exceeds the first threshold in response to the comparison of the signal from the sensor to the first threshold or the quality of the grain exceeds the second threshold in response to the comparison of the signal from the sensor to the second threshold, the controller is configured to operably adjust the second machine setting. In one example, the sensor is configured to detect the quantity of grain loss from one or more of the cleaning shoe, the separating section, and the header; the sensor is configured to communicate the quantity of grain loss from the one or more of the cleaning shoe, the separating section, and the header to the controller; wherein the controller is configured to determine a total quantity of grain loss based on the quantity of grain loss detected by the sensor from the one or more of the cleaning shoe, the separator, and the header. In another example, the sensor is configured to detect one or more of foreign material, unthreshed grain, or broken grain when detecting the quality of the grain, wherein the sensor is configured to communicate the signal regarding the quality of the grain to the controller, the signal regarding the quality of grain including information about the foreign material, unthreshed grain, or broken grain detected by the sensor, and wherein the controller is configured to determine the quality of the grain based on the information about the foreign material, unthreshed grain, or broken grain.

According to a second implementation of the present disclosure a control system for an agricultural machine configured to perform a harvesting operation to harvest a crop includes a controller configured to store a first threshold or a second threshold, the first threshold related to a quantity of grain loss by the agricultural machine during the harvesting operation and the second threshold related to a quality of grain harvested during the harvesting operation, and a sensor disposed in communication with the controller, the sensor configured to detect the quantity of grain loss or the quality of the grain during the harvesting operation, wherein, during the harvesting operation, the sensor is configured to send a signal to the controller corresponding to the quantity of grain loss or the quality of the grain, and wherein the controller is configured to compare the signal from the sensor to either the first threshold or the second threshold and determine whether the quantity of grain loss exceeds the first threshold in response to the comparison between the signal from the sensor and the first threshold or the quality of the grain exceeds the second threshold in response to the comparison between the signal from the sensor and the second threshold.

In some examples, the controller is configured to adjust a machine setting when the quantity of grain loss exceeds the first threshold or when the quality of the grain exceeds the second threshold. In some examples, the machine setting comprises a rotor speed, a threshing clearance, a fan speed, a chaffer clearance, or a sieve clearance. In some implementations, the sensor comprises a plurality of sensors, where a first sensor of the plurality of sensors is configured to detect the quantity of grain loss and a second sensor of the plurality of sensors is configured to detect the quality of the grain. In some examples, the controller is configured to receive an input corresponding to the first threshold or the second threshold from an input device, the input received by the controller including a value based on a linear numeric scale or a percentage.

According to a third implementation, a method for adjusting a machine setting in a work machine configured to perform a harvesting operation to harvest a crop, the method comprising: providing a control system including a controller and a sensor; receiving by the controller a plurality of thresholds including a first threshold corresponding to a quantity of grain loss during the harvesting operation and a second threshold corresponding to an amount of foreign material; detecting by the sensor during the harvesting operation a quantity of grain loss or a quality of grain; comparing, by the controller, the quantity of grain loss to the first threshold or the quality of grain to the second threshold; identifying, by the controller, a grain loss issue in response to the quantity of grain loss being greater than the first threshold or a grain quality issue in response to the quality of grain being greater than the second threshold; and adjusting a setting on the work machine when the controller identifies a grain loss issue or a grain quality issue.

According to some examples, when a grain loss issue or a grain quality issue is identified, determining a first subcategory of a plurality of subcategories corresponding to the grain loss issue or grain quality issue identified by the controller, the first subcategory determined via a magnitude process where the controller assigns a variable to each of the plurality of subcategories, each variable having a magnitude; and wherein the first subcategory is determined by the controller based on the variable of the plurality of subcategories having the greatest magnitude in comparison to the magnitudes of the variables of the other subcategories of the plurality of subcategories.

In some implementations, when a grain loss issue or a grain quality issue is identified, determining a first subcategory of a plurality of subcategories corresponding to the grain loss issue or grain quality issue identified by the controller, the first subcategory determined via a relative change process where the controller assigns a variable to each of the plurality of subcategories, each variable corresponding to a change over a predetermined period of time; wherein the first subcategory is determined by the controller based on the variable of the plurality of subcategories corresponding to the change over the predetermined period of time that exceeds the variables of the other subcategories of the plurality of subcategories.

These and other features of the present disclosure will become more apparent from the following description of the illustrative implementations.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings, wherein:

FIG. 1 is a side view of an agricultural machine configured to harvest and process crop;

FIG. 2 is a block diagram of one example of components associated with automation settings of an agricultural machine;

FIG. 3 is a method for determining one or more issues in a grain loss system;

FIG. 4 is a partial view of a block diagram for a grain quality method that identifies one or more issues in a grain quality system;

FIG. 5 is a partial view of the grain quality method of FIG. 4 for identifying one or more issues in a grain quality system when foreign material light is one issue;

FIG. 6 is a partial view of the grain quality method of FIG. 4 for identifying one or more issues in a grain quality system when foreign material heavy is one issue;

FIG. 7 is a partial view of the grain quality method of FIG. 4 for identifying one or more issues in the grain quality system when unthreshed grain is one issue;

FIG. 8a is one example of a graph illustrating grain loss with respect to time for an agricultural machine when no issue is detected;

FIG. 8b is one example of a graph illustrating grain loss with respect to time for an agricultural machine when separator loss is detected due to its magnitude of loss;

FIG. 8c is one example of a graph illustrating grain loss with respect to time for an agricultural machine when shoe loss is detected due to the relative change in shoe loss over time;

FIG. 8d is one example of a graph illustrating grain loss with respect to time for an agricultural machine when separator loss is detected due to its magnitude of loss and shoe loss is detected due to the relative change in shoe loss over time; and

FIG. 9 is a block diagram of a control system for detecting grain loss issues and grain quality issues for an agricultural machine and for making adjustments to the settings of the agricultural machine;

Corresponding reference numerals are used to indicate corresponding parts throughout the several views.

### DETAILED DESCRIPTION

The implementations of the present disclosure described below are not intended to be exhaustive or to limit the disclosure to the precise forms in the following detailed description. Rather, the implementations are chosen and described so that others skilled in the art may appreciate and understand the principles and practices of the present disclosure.

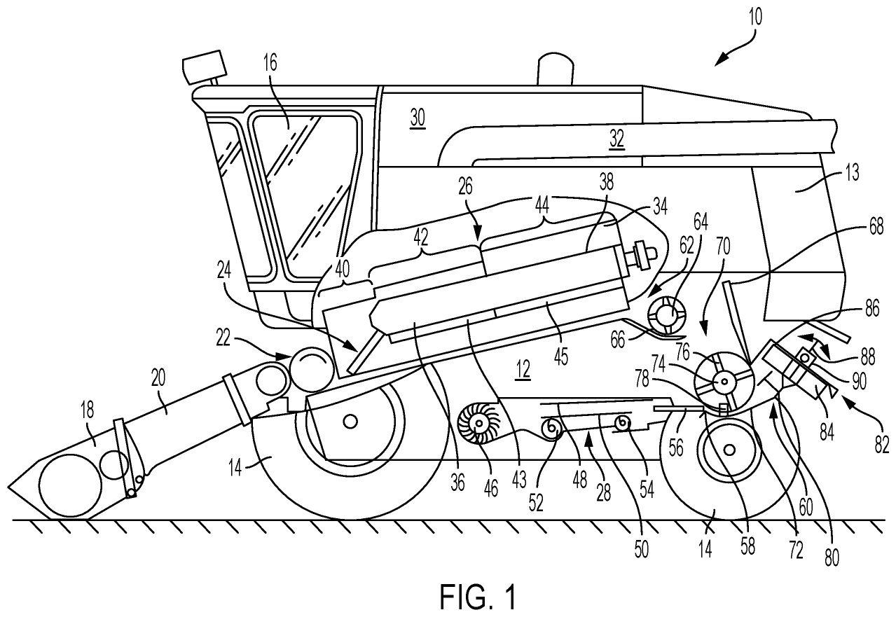

In FIG. 1, an implementation of an agricultural machine 10 is shown. The agricultural machine 10 includes a frame 12 and one or more ground engaging mechanism, such as wheels 14 or tracks, that are in contact with an underlying ground surface. In the illustrative implementation, the wheels 14 are coupled to the frame 12 and are used for propulsion of the agricultural machine 10 in a forward operating direction (which is to the left in FIG. 1) and in other directions. In some implementations, operation of the agricultural machine 10 is controlled from an operator's cab 16. The operator's cab 16 may include any number of controls for controlling the operation of the agricultural machine 10, such as a user interface. In some implementations, operation of the agricultural machine 10 may be conducted by a human operator in the operator's cab 16, a remote human operator, or an automated system.

A cutting head 18 is disposed at a forward end of the agricultural machine 10 and is used to harvest crop (such as corn) and to conduct the harvested crop to a slope conveyor 20. The slope conveyor 20 conducts the harvested crop to a guide drum 22. The guide drum 22 guides the harvested crop to an inlet 24 of a threshing assembly 26, as shown in FIG. 1. The threshing assembly 26 includes a housing 34 and one or more threshing rotors. A single threshing rotor 36 is shown in FIG. 1, and the threshing rotor 36 includes a drum 38. The threshing assembly 26 further includes a charging section 40, a threshing section 42, and a separating section 44. The charging section 40 is arranged at a front end of the threshing assembly 26, the separating section 44 is arranged at a rear end of the threshing assembly 26, and the threshing section 42 is arranged between the charging section 40 and the separating section 44. The threshing assembly 26 further includes a thresher basket 43 that is positioned in the threshing section 42 and a separating grate 45 that is positioned in the separating section 44.

The separating section 44 may include the separating grate 45 with the threshing rotor 36 at least partially extending through the separating grate 45. In some examples, the separating grate 45 may have a concave shape. The rotor may engage and agitate the crop to dislodge grain, the dislodged grain falling through the separating grate and the crop moving downstream through the separating section in the longitudinal direction and to the rear of the separating section 44.

Harvested crop that includes grain, such as corn, and material other than grain (MOG) falls through the thresher basket 43 and through the separating grate 45. The harvested crop may be directed to a cleaning shoe, or a clean crop routing assembly 28 with a blower 46 and sieves 48, 50 with louvers. The sieves 48, 50 can be oscillated in a fore-and-aft direction. The cleaning shoe, or clean crop routing assembly 28 removes the MOG and guides grain over a screw conveyor 52 to an elevator for grain. The elevator for grain deposits the grain in a grain tank 30, as shown in FIG. 1. The grain in the grain tank 30 can be unloaded by means of an unloading screw conveyor 32 to a grain wagon, trailer, or truck, for example.

Harvested crop remaining at a rear end of the sieve 50 is again transported to the threshing assembly 26 by a screw conveyor 54 where it is reprocessed by the threshing assembly 26. Harvested crop remaining at a rear end of the sieve 48 is conveyed by an oscillating sheet conveyor 56 to a lower inlet 58 of a crop debris routing assembly 60. Harvested crop at the threshing assembly 26 is processed by the separating section 44 resulting in straw being separated from other material of the harvested crop. The straw is ejected through an outlet 62 of the threshing assembly 26 and conducted to an ejection drum 64. The ejection drum 64 interacts with a sheet 66 arranged underneath the ejection drum 64 to move the straw rearwardly. A wall 68 is located to the rear of the ejection drum 64 and guides the straw into an upper inlet 70 of the crop debris routing assembly 60.

The crop debris routing assembly 60 includes a chopper housing 72 and a chopper rotor 74 arranged in the chopper housing 72. The chopper rotor 74 rotates, for example, in a counter-clockwise direction about an axis that extends, for example, perpendicular to the forward operating direction. The chopper rotor 74 includes a plurality of chopper knives 76 that are distributed around a circumference of the chopper rotor 74. The crop debris routing assembly 60 further includes opposing knives 78 that are coupled to the chopper housing 72 and extend toward the chopper rotor 74. The chopper knives 76 of the chopper rotor 74 cooperate with the opposing knives 78 to chop the straw into smaller pieces.

One or more spreaders are provided downstream of an outlet 80 of the crop debris routing assembly 60. One spreader 82 is shown in FIG. 1. The spreader 82 may include a number of impeller blades 84, each of which is connected to a disk 86 that rotates about a central axis 88. The impeller blades 84 extend downwardly from the disk 86 and, for example, radially outwardly from the central axis 88. The disk 86 and the impeller blades 84 coupled thereto are rotatably driven by a motor 90 that may be for example, a hydraulic motor. Chopped straw is moved through the outlet 80 of the crop debris routing assembly 60 to the spreader 82. Rotation of the impeller blades 84 of the spreader 82 spreads the chopped straw as it exits the agricultural machine 10.

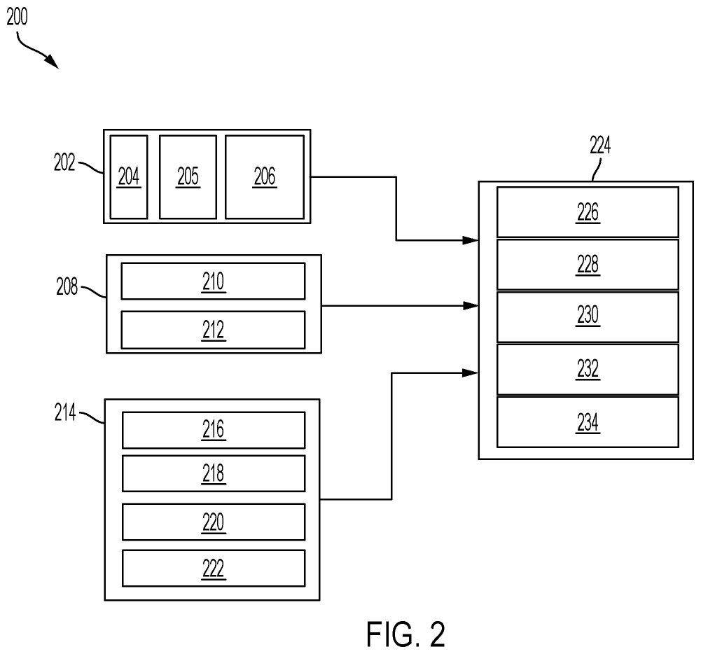

Referring now to FIG. 2, one implementation of an agricultural system for the automation of grain loss and grain quality within the harvester 10 is illustrated. As described in more detail below, grain loss may refer to grain lost from the agricultural machine, and grain quality may refer to the quality of the grain, or how much foreign material that is with the cleaned grain. In some examples, foreign material may include, for example, foreign material light, foreign material heavy, unthreshed grain, and broken grain.

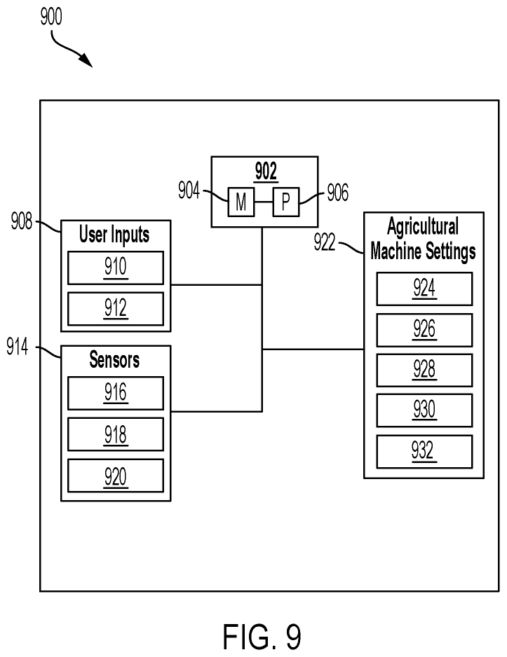

The agricultural system 200 may include user inputs 202, a grain loss sensing system 208 (or systems), a grain quality sensing system 214 (or systems), and machine settings 224. The user inputs 202, grain loss sensing system 208, and grain quality sensing system 214 may be coupled to the machine settings 224 via a controller 902 (see FIG. 9), and the controller 902 may adjust the machine settings 224. In some examples, the controller 902 may include a plurality of controllers, and the controller 902 may communicate with at least one of the plurality of controllers to control the machine settings 224. In one example, a rotor controller may be included in the plurality of controllers and may control the rotor speed 226. In this example, the controller 902 may instruct the rotor controller to adjust the rotor speed 226, and the rotor controller may correspondingly adjust the rotor speed 226.

The user inputs 202 may refer to inputs provided by a user or operator of the harvester 10. In some examples the user inputs 202 may be input by the user or operator via a display, and the display may communicate the user inputs 202 to the controller 902. In one example, there may be three user inputs. The three user inputs may include threshold values for acceptable total loss 204, acceptable total broken grain 205, and acceptable total foreign material 206. Acceptable total loss 204 may include the acceptable total loss from the grain loss sensing system 208 such as, for example, the amount of loss from the separator and a cleaning shoe. In some examples, acceptable total loss 204 may include header loss and/or may include other areas of loss. The cleaning shoe may refer to the clean crop routing assembly 28, as shown in the implementation of FIG. 1, and may be referred to herein as the shoe loss 212. Acceptable total broken grain 205 may refer to the acceptable total amount of grain that is broken, either mechanically broken via the harvester 10 or otherwise broken grain. Acceptable total foreign material 206 may refer to one or more of the acceptable total amount of foreign material light 216, foreign material heavy 218, and unthreshed grain 220 in the grain tank 30 or otherwise with the cleaned grain.

The user inputs 202 may provide a threshold level of acceptable total loss 204, acceptable total broken grain 205, and acceptable total foreign material 206. In some examples, the inputs may be a number on a scale such as a linear numeric scale. In some examples, the scale may be between 0 and 10 wherein 0 represents the lowest amount of grain loss acceptability and 10 represents the highest amount of grain loss acceptability. In some examples, the inputs may be input as a number on a sliding scale with a different range than between 0 and 10, such as, for example, a scale between 1 and 10, 0 and 20, 0 and 100, or a similar linear scale. In other examples, a non-linear scale may be used. The user inputs 202 may also be provided as a percent (e.g., 0-100%). In some examples, one or more of the acceptable total loss 204, total broken grain 205, and total foreign material 206 may be provided as a percent of total harvested grain by the harvester 10. In some implementations, the total foreign material 206 may be provided as a percent of mass or volume of grain harvested by the harvester 10. In some examples, the user may be provided with historical data showing average values that may be for the acceptable total loss 204, acceptable total broken grain 205, and acceptable total foreign material 206. In some examples, the user may be provided a recommended value or percent to select for each of the user inputs 202. The recommended value or percentage may be displayed on a display in the cab 16, on an application on a mobile device, or on a computing device.

The user inputs 202 may be converted to a unit value. In some examples, the user inputs 202 may be converted via the controller 902. In some examples, the unit value for acceptable total loss 204 may be area based, such as, for example, bushels per acre. In other examples, the unit value for acceptable total foreign material 206 may be mass-based such as, for example, an estimated mass of foreign material light 216, foreign material heavy 218, and unthreshed grain 220 in the grain tank 30. In some examples, the threshold value input for acceptable total broken grain 205 may be converted to a unit value, and the unit value for acceptable total broken grain 205 may be mass-based, such as, for example, the mass of broken grain 222 in the grain tank 30. Other user inputs 202 are also considered herein such as, for example, a range of numbers wherein the range is larger or smaller than eleven. In an example, the user inputs 202 may be a threshold number of acceptable total loss 204 per time unit, such as per minute, per second or intervals thereof. In some examples, the user inputs 202 may be a threshold amount of acceptable total foreign material 206 per time unit, such as per second, per minute, or intervals thereof. In some examples, the user inputs may be a threshold amount of acceptable total broken grain 205 per time unit, such as per second, per minute, or intervals thereof.

A non-limiting list of classification categories of grain and non-grain material may include clean grain, broken grain 222, foreign material light 216 (also referred to as MOG light), foreign material heavy 218 (also referred to as MOG heavy) and unthreshed grain 220. In some examples, the classification categories for grain quality and grain loss may be referred to as subcategories. According to these examples, a subcategory of grain quality may include clean grain, broken grain 222, foreign material light 216, foreign material heavy 218, or unthreshed grain 220, among others, and the subcategory for grain loss may include separator loss 210 and shoe loss 212. In some examples, the subcategory for broken grain may be broken grain. It will be understood that grain classified as clean grain may include grain that has been completely threshed, broken grain 222 may include partial clean grains, such as grain that has been severed or crushed in some way, foreign material light 216 is relatively lightweight chaff or other non-grain material such as leaves and husks that may be readily blown a the fan, foreign material heavy 218 is non-grain material that is denser or heavier to the extent that it is not readily blown away, such as sticks, bark and so on, and “unthreshed” grain 220 is grain that has not been separated from its husk. Various other definitions for these categories may be provided.

The agricultural system 200 may include the grain loss sensing system 208. Grain loss may include a portion of the crop grown in the field that is not captured by the harvester 10 and remains in the field. Grain loss may occur through various functions harvester 10. Grain loss may occur if the header is too high and cuts above the grain. Grain loss may occur if the grain is threshed at the head and spills to the ground before entering the harvester 10. Grain loss may occur if the grain exits the separator due to excessive throughput and/or bad settings. Grain loss may also occur if the grain exits the cleaning shoe due to excessive throughput and/or bad settings. Grain loss may occur through gaps in the machine components when grain leaks to the ground through the gaps. Grain loss may occur due to the grain reaching maturity and the plants allow the grain to spill to the ground before harvest. Grain loss may occur due to weather events, such as hail, that cause the grain to spill to the ground before harvest. In some examples, crop and weather events that cause grain loss may be classified as pre-harvest losses.

The grain loss sensing system 208 may include separator loss 210 and shoe loss 212, among other losses. Separator loss 210 may include the amount of grain that is detected as lost from the separating section 44 of the harvester 10. Separator loss 210 may be measured by one or more separator loss sensors 916 (see FIG. 9). Separator loss 210 may include the grain lost via the separating section 44 of the harvester 10 and detected by the one or more separator loss sensors 916. Shoe loss 212 may include grain that is detected as lost via the cleaning shoe. In some examples, one or more shoe loss sensors 918 (see FIG. 9) may detect material that is lost via the cleaning shoe. In some examples, the sensors 914 may not differentiate between separator loss 210 and shoe loss 212, and instead the sensors 914 may detect a total amount of loss from the grain loss sensing system 208.

The agricultural system 200 may also include the grain quality sensing system 214, which may include foreign material light 216, foreign material heavy 218, unthreshed grain 220, and broken grain 222 detected by the grain quality sensing system 214. In some examples, the grain quality sensing system may include other classification categories, or may not include all of the above classification categories. In one example, the classification categories included in the grain quality sensing system 214 may include foreign material, unthreshed grain 200, and broken grain 222. In some examples, clean grain may be included in the grain quality sensing system. The quality of grain harvested by the harvester 10 may be determined by the amount of clean grain that is free of mechanical damage and the amount of foreign material, or MOG. Grain that is excessively damaged or crushed by the harvester 10 could cause a loss in value of the grain, or in the grain quality. Grain that contains a high amount of foreign material or MOG, such as leaves or stalk material, could cause a loss in quality of the grain. Grain that has a high amount of grain with the husks still attached could cause a loss in the quality of the grain. The grain harvested will have a higher quality if it is free of the aforementioned defects, among others.

In some examples, a grain quality sensor 920 may be mounted to the clean grain elevator. The grain elevator may deposit grain from the harvester 10 to the grain tank 30. The grain quality sensor 920 may take an image of grain that is being delivered to the grain tank 30 via the grain elevator. In some examples, the grain quality sensor 920 may capture an image of grain in the grain tank 30. In some examples, the grain quality sensor 920 may analyze the image and classify the material in the image as foreign material light 26, foreign material heavy 218, unthreshed grain 220, and/or broken grain 222. In some examples, the grain quality sensor 920 may communicate the image to a processing unit, such as a computer, the controller 902, or another type of processor, and the processing unit may identify the material in the image as foreign material light 216, foreign material heavy 219, unthreshed grain 220, and/or broken grain 222.

In some examples, the grain quality sensor 920 may capture a plurality of images in one or more intervals. The intervals may be defined by software included in the grain quality sensor 920. In some examples, the one or more intervals may be based on the flowrate of harvested crop moving towards the grain tank 30. In other examples, the one or more intervals may be time-based, and the grain quality sensor 920 may capture an image every 0.5 seconds, although other intervals less than every 0.5 seconds or greater than 0.5 seconds may be possible.

The one or more intervals may be predefined and may be adjusted by a user or operator of the harvester 10. In some examples, a minimum number of intervals for the controller 902 to determine excessive grain quality or grain loss issue may be adjusted via a display in the cab 16. In one such example, a representation of the minimum number of intervals (e.g., a numerical scale or a percentage) may be displayed on the display and the user or operator may adjust the minimum number of intervals by adjusting the representation of the interval. For example, the user may select a number on a linear numeric scale such as, for example, a number between 1 and 5, with 1 representing the lowest number of images and 5 represents the highest amount images. In other examples, the user or operator may select a number between a different range, such as a number between 1 and 7, between 0 and 10, between 1 and 100, or a similar scale. In other examples, a non-linear scale may be used. In other examples, the representation of the interval may be a percent (e.g., 0-100%) and the user or operator may adjust interval by adjusting the percentage. According to some implementations, the minimum number of intervals may be adjusted remotely or via an automated system. The controller 902 may convert the representation of the minimum number of intervals input by the user or operator (e.g., the number in a linear scale or as a percentage) to an actual interval number of images.

In some examples the user inputs 202, grain loss sensing system 208, and grain quality sensing system 214 may communicate with the controller 902, and the controller 902 may automatically adjust one or more machine settings 224. The machine settings 224 may include rotor speed 226, threshing clearance 228, fan speed 290, chaffer clearance 232, and sieve clearance 234. In some examples, when one or more of the acceptable total loss 204, acceptable total broken grain 205, or acceptable total foreign material 206 of the harvester 10 are greater than the acceptability threshold defined by the user inputs 202, the controller 902 may automatically adjust the rotor speed 226, the threshing clearance 228, the fan speed 230, the chaffer clearance 232, or the sieve clearance 234, among other machine settings, until the acceptability threshold is satisfied.

The rotor speed 226 may be adjusted by adjusting the speed of the threshing rotor 36. The speed of the threshing rotor 36 may be adjusted by increasing or decreasing the rotations per minute (rpms) of the threshing rotor 36. In some examples, if loss from the grain loss sensing system 208 exceeds the user inputs 202, then the speed of the threshing rotor 36 may be increased.

In some examples, the thresher clearance 228 may be defined as the distance between the housing 24 and the one or more thresher rotors. The thresher clearance 228 may be measured in units of distance, such as millimeters, inches, yards, or the like. In some examples, when the foreign material light 216, foreign material heavy 218, unthreshed grain 220, and/or broken grain 214 is greater than an associated threshold user input 202 values for acceptable total broken grain 205 and/or acceptable total foreign material 206, the threshing clearance 228 may be adjusted (e.g., automatically adjusted) by increasing the threshing clearance 228 by one or more millimeters. In some examples, the threshing clearance 228 may be increased by less than one millimeter. In other examples, the threshing clearance 228 may be decreased.

The separating section 44 may include a fan. In some examples the fan may be downstream relative to the chopper housing 72 and may generally separate extraneous plant matter from the crop. In other examples, the fan may be upstream relative to the chopper housing 72. In some examples, the blower 46 may be a fan. The fan may be a fan powered by a rotor and the speed of the fan may be adjusted by adjusting the speed of the rotor. Fan speed 230 may refer to the speed of the fan or the speed of the rotor that powers the fan. In some examples, if one or more of the measurements from the grain loss sensing system 208 or the grain quality sensing system 214 are greater than the acceptability threshold set by the user inputs 202, the harvester 10 may decrease the fan speed 230. The harvester 10 may decrease the fan speed by decreasing the speed of the rotor for the fan. In some examples, the harvester 10 may increase the fan speed by increasing the speed of the rotor for the fan.

The harvester 10 may also include a chaffer and one or more sieves 48, 50. The chaffer may have rows of protruding members, referred to herein as chaffer fingers, and the chaffer may move MOG to the chopper and the grain to the one or more sieves 48, 50. The harvester 10 may have an upper sieve 48 and a lower sieve 50, where each sieve 48, 50 has one or more rows of protruding members referred to herein as sieve fingers. In some examples, the chaffer clearance 232 may refer to the distance between chaffer fingers in adjacent rows, and the sieve clearance 234 may refer to the distance between sieve fingers in adjacent rows. In some examples, the chaffer clearance 232 may refer to a height of the chaffer fingers, wherein the height of the chaffer fingers may be the difference between the current height of the chaffer fingers and the height of the chaffer fingers in a closed position. Similarly, in some examples, the sieve clearance 234 may refer to a height of the sieve fingers, wherein the height of the sieve fingers may be the difference between the current height of the sieve fingers and the height of the sieve fingers in a closed position. The chaffer clearance 232 may be adjusted by moving the chaffer fingers, and the sieve clearance 234 may be adjusted by moving the sieve fingers. The chaffer clearance 232 and sieve clearance 234 may be defined in units of distance, such as millimeters. In some examples, the chaffer and sieve clearance 232, 234 may be defined in inches, yards, or any other unit of distance.

When a signal, detected value, or measured value from the grain loss sensing system 208 and the grain quality sensing system 214 is greater than acceptability thresholds set in the user inputs 202, the controller 902 may adjust the chaffer clearance 232 and/or the sieve clearance 234, among other adjustments. In some examples, when the foreign material light 216, foreign material heavy 218, or unthreshed grain 220 is greater than the acceptable total foreign material 206, then the controller 902 may adjust the chaffer clearance 232, the sieve clearance 234, or both the chaffer and sieve clearance 232, 234. In some examples, when the amount of measured broken grain 222 in the grain tank is greater than the total threshold value of acceptable broken grain 205, the controller 902 may adjust one or more of the chaffer clearance 232 and the sieve clearance 234. In still another example, if the amount of loss from the grain loss sensing system 208 is greater than the acceptable total loss 204 input by the user, the controller 902 may adjust one or more of the chaffer clearance 232 and the sieve clearance 234. In some examples, one or more of the chaffer and sieve clearance 232, 234 may be increased. In other examples, one or more of the chaffer and sieve clearance 232, 234 may be decreased.

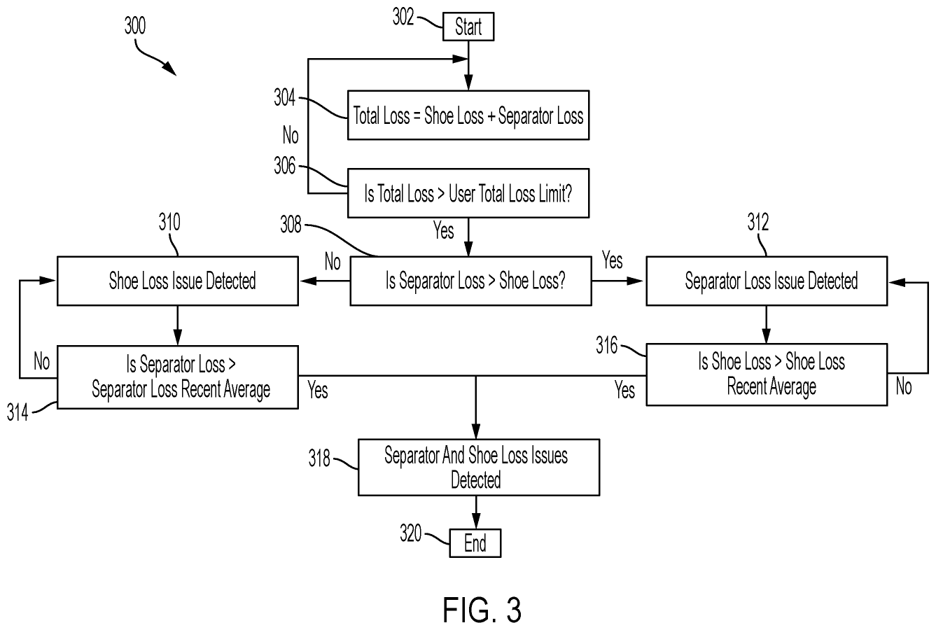

Referring now to FIG. 3, an implementation of a grain loss method 300 is illustrated. The grain loss method 300 may be executed to determine whether there is excessive grain loss in the separating section 44, the cleaning shoe, or both the separating section and cleaning shoe. If so, the method 300 may be executed to determine where an underlying issue exists that is causing the excess grain loss. The grain loss method 300 may be executed by the controller 902, for example, of the control system 900 in FIG. 9. The method 300 may begin in block 302. In block 304, the controller 902 may calculate the total loss, which in the illustrated implementation of FIG. 3 is the sum of the shoe loss 212 and the separator loss 210.

In block 306, a determination may be made by the controller 902 whether the total loss calculated in block 304 is greater than an acceptability threshold or limit for the acceptable total loss 204 set by the user or operator of the harvester 10. When the total loss is not greater than the total loss acceptability threshold or limit in block 306, then the controller 902 may determine there is no excessive grain loss detected, and the method 300 may return to block 304 where the controller 902 calculates the total loss as the sum of the shoe loss 212 and the separator loss 210. When the total loss is determined by the controller 902 to be greater than the acceptability threshold or limit for the acceptable total loss 204 set by the user or operator of the harvester 10, the controller 902 may detect an excessive grain loss and the method 300 advances to block 308. In block 308, a determination may be made by the controller 902 as to whether separator loss 210 is greater than shoe loss 212.

When the controller 902 determines that separator loss 210 is greater than shoe loss 212 in block 308, then the controller 902 determines a shoe loss issue is detected in block 310. When the separator loss 210 is not greater than the shoe loss 212 in block 308, however, then the controller 902 may determine a separator loss issue is detected in block 312 of the method 300. In some examples, the separator loss 210 may be equal to the shoe loss 212 in block 308, and in this event the controller 902 may determine there is both a separator loss issue and shoe loss issue. When the controller 902 determines there is a shoe loss issue in block 310, a determination by the controller 902 may be made whether the separator loss 210 is greater than a recent average of the separator loss determined by the controller 902 in block 314. If the separator loss 210 is greater than a recent average of the separator loss in block 314, then the controller 902 may determine there is both a separator loss issue and a shoe loss issue in block 318 of the method 300. When the separator loss 210 is not greater than the separator loss recent average in block 314, then the method 300 returns to block 310 where the controller 902 determines that there is only a shoe loss issue detected. In some examples, separator loss recent average may be the separator loss 210 detected over a previous period of time. In some examples, the period of time may be the previous one minute. In other examples, the period of time may be less than the previous one minute, such as the previous 5 seconds, 15 seconds, 35 seconds, 45 seconds, or any other previous period of time or interval that is less than one minute. In other examples, the period of time may be greater than one minute, such as more than 60 seconds, more than 90 seconds, more than 120 seconds, five minutes, ten minutes, fifteen minutes, greater than fifteen minutes, or another interval or period of time. According to some implementations, the recent average may be calculated over a period, wherein the period is a number of images captured by the grain quality sensor 920.

When a separator loss issue is detected by the controller 902 in block 312, then a determination may be made by the controller 902 in block 316 whether the shoe loss 212 is greater than a shoe loss recent average. In some examples, the shoe loss recent average may be the shoe loss 212 determined by the controller 902 over a previous period of time. In some examples, the period of time may be the previous one minute. In other examples, the period of time may be less than the previous one minute, such as the previous 5 seconds, 15 seconds, 35 seconds, 45 seconds, or any other previous period of time or interval that is less than one minute. In other examples, the period of time may be greater than one minute, such as more than 60 seconds, more than 90 seconds, more than 120 seconds, five minutes, ten minutes, fifteen minutes, greater than fifteen minutes, or another interval or period of time. In block 316 of method 300, when the controller 902 determines the shoe loss 212 is greater than the shoe loss recent average, then the controller 902 may determine there is both a separator loss issue and a shoe loss issue in block 318. When the shoe loss, however, is not greater than the shoe loss recent average, then the controller 902 may determine that there is only a separator loss issue in block 312. Once the controller 902 executes the grain loss method 300 and determines whether there is a shoe loss issue, a separator loss issue, or both a separator loss issue and a shoe loss issue, the grain loss method 300 may advance to block 320 and end.

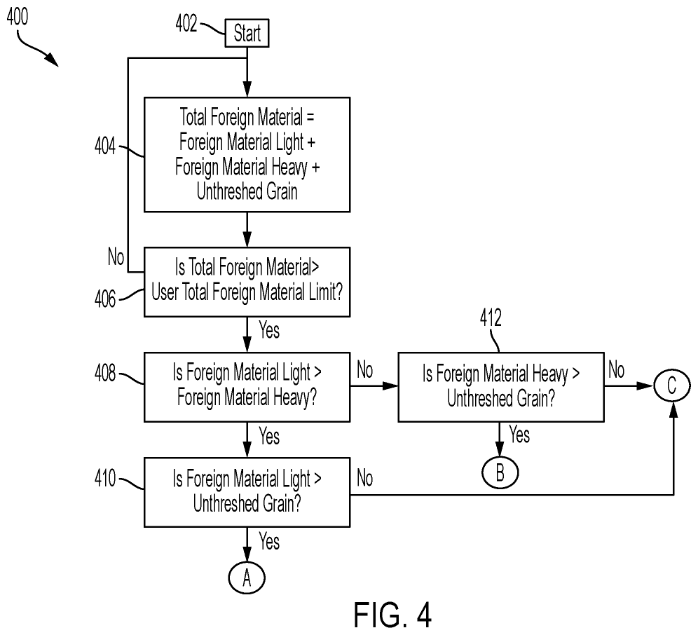

Referring now to FIGS. 4-7, a grain quality method 400 is illustrated. The controller 902 may execute the method 400 to determine whether there is excessive foreign material or unthreshed grain with the grain harvested and cleaned by the harvester 10. If so, the method 400 may be executed to determine whether foreign material light, foreign material heavy, or unthreshed grain is causing the excessive grain quality issue.

In block 402, the controller 902 begins executing method 400. The controller 902 may receive foreign material light 216, foreign material heavy 218, and unthreshed grain 218 data from one or more sensors, such as, for example, from a grain quality sensor 920. The controller 902 may calculate the total foreign material as a summation of the foreign material light 216, foreign material heavy 218, and unthreshed grain 220 detected by the grain quality sensor in block 404. In block 406, a determination by the controller 902 may be made whether the total foreign material is greater than the acceptable total foreign material 206 input by the user or operator of the harvester 10. The acceptable total foreign material 206 may be an acceptability threshold or limit input by the user or operator of the harvester 10 defining acceptable total foreign material 206 in the grain tank or otherwise with the clean grain. When the controller 902 determines the total foreign material is not greater than the user acceptable total foreign material limit 206, then the method 400 may return to block 404, where the controller 902 calculates the total foreign material as the summation of the foreign material light 216, foreign material heavy 218, and the unthreshed grain 220.

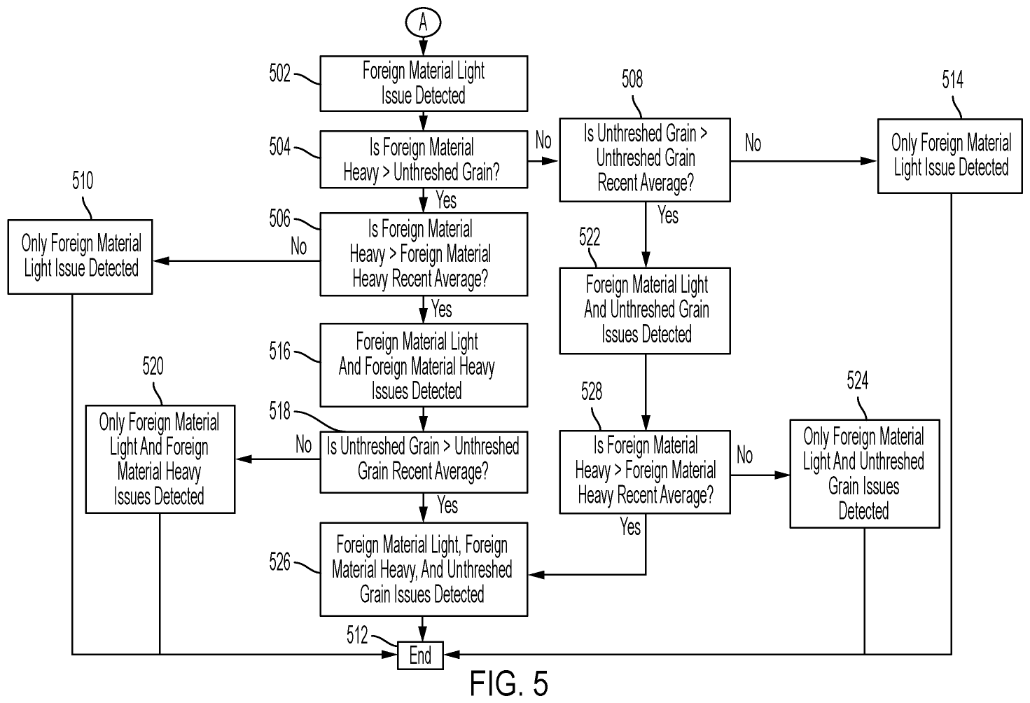

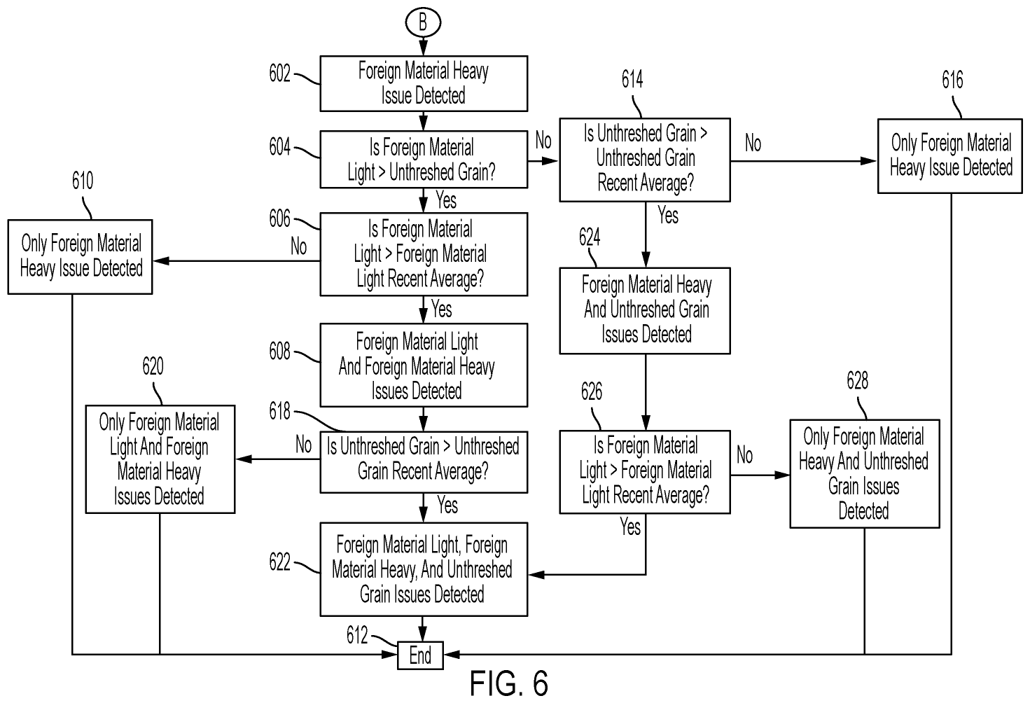

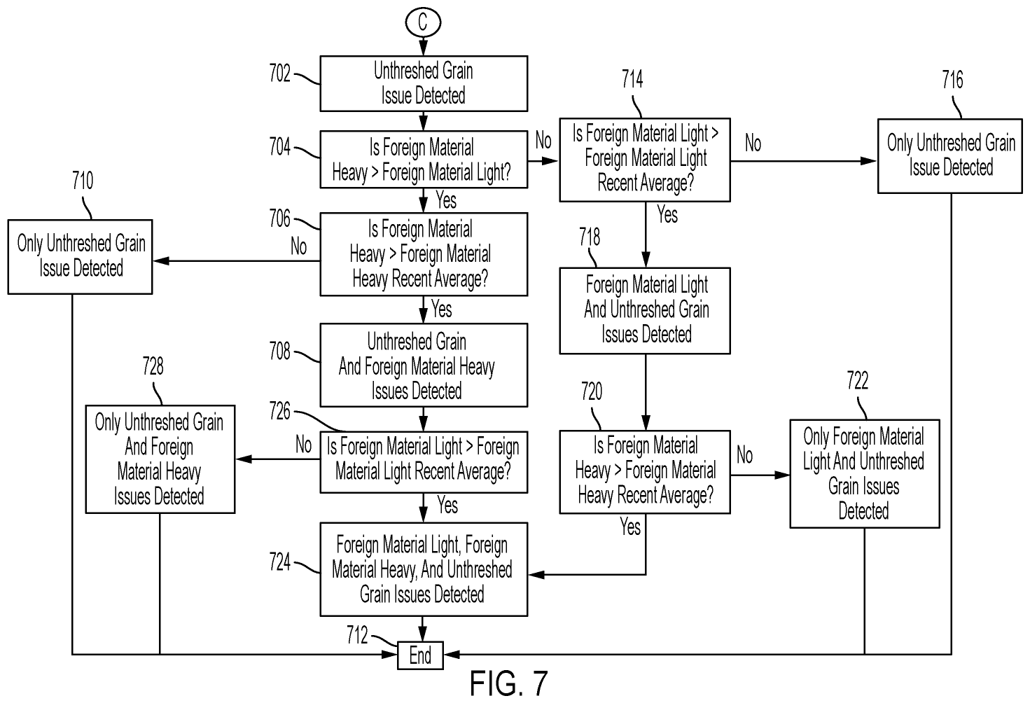

In block 406, when the controller 902 determines the total foreign material is greater than the acceptability threshold or limit for acceptable total foreign material 206, then the controller 902 may determine whether the foreign material light 216 is greater than the foreign material heavy 218 in block 408. In block 408, when the foreign material light 216 is greater than the foreign material heavy 218, the controller 902 may determine whether the foreign material light 216 is also greater than the unthreshed grain 220 in block 410. However, in block 408, when the foreign material light 216 is not greater than the foreign material heavy 218, then the controller 902 may determine whether the foreign material heavy 218 is greater than the unthreshed grain 220 in block 412. In block 410, when the foreign material light 216 is greater than the foreign material heavy 218, the controller 902 may determine a foreign material light issue is detected in block 502 of FIG. 5. However, in block 410, when foreign material light 216 is not greater than unthreshed grain 220, the controller 902 may determine an unthreshed grain issue is detected in block 702 of FIG. 7. In block 412, in the instance when the foreign material heavy 218 is greater than unthreshed grain 220, then the controller 902 may determine a foreign material heavy 218 issue is detected in block 602 of FIG. 6. In block 412, when controller 902 determines the foreign material heavy 218 is not greater than unthreshed grain 220, then the controller 902 may determine an unthreshed grain issue is detected, as in block 702.

Referring now to FIG. 5, the controller 902 may determine that there is a foreign material light issue in block 502. In block 504, a determination may be made by the controller 902 as to whether foreign material heavy 218 is greater than unthreshed grain 220. When the controller 902 determines foreign material heavy 218 is greater than unthreshed grain 220 in block 504, then a determination is made by the controller 902 whether the foreign material heavy 218 is greater than a foreign material heavy recent average in block 506. In some examples, the foreign material heavy recent average may be the foreign material heavy 218 determined by the controller 902 over a previous period.

According to some examples, the period may be based on the flowrate of harvested crop moving towards the grain tank 30. Each period may include a plurality of intervals, wherein each interval corresponds to an image captured by the grain quality sensor 920. In some examples, the controller 902 may calculate the recent average over a period, wherein the period includes, for example, 5 intervals, 10 intervals, 30 intervals, 100 intervals, or the like. According to some implementations, the plurality of intervals may be defined by software in the grain quality sensor 920. In other examples, the plurality of intervals may be time-based, and the grain quality sensor 920 may capture an image every 0.5 seconds, although other intervals less than every 0.5 seconds or greater than 0.5 seconds may be possible. When the foreign material heavy 218 not greater than the foreign material heavy recent average, the controller 902 may determine only a foreign material light issue is be detected in block 514. When the controller 902 determines there is a foreign material light issue in block 510, the grain quality method 400 may advance to block 512 and end.

In block 504, when foreign material heavy 218 is not greater than unthreshed grain 220, a determination may be made by the controller 902 as to whether unthreshed grain 220 is greater than an unthreshed grain recent average in block 508. In some examples, the unthreshed grain recent average may be the unthreshed grain 220 detected by the grain quality sensor 920 and communicated to the controller 902 over a previous period.

According to some examples, the period may be based on the flowrate of harvested crop moving towards the grain tank 30. Each period may include a plurality of intervals, wherein each interval corresponds to an image captured by the grain quality sensor 920. In some examples, the controller 902 may calculate the recent average over a period, wherein the period includes, for example, 5 intervals, 10 intervals, 30 intervals, 100 intervals, or the like. According to some implementations, the plurality of intervals may be defined by software in the grain quality sensor 920. In other examples, the plurality of intervals may be time-based, and the grain quality sensor 920 may capture an image every 0.5 seconds, although other intervals less than every 0.5 seconds or greater than 0.5 seconds may be possible. When unthreshed grain 220 is not greater than the unthreshed grain recent average in block 508, then the controller 902 may determine there is only a foreign material light issue detected in block 514. When the controller 902 determines only a foreign material light issue is detected in block 514, the grain quality method 400 may advance to block 512 and end.

In block 506 of method 400, when foreign material heavy 218 is greater than the foreign material recent average the controller 902 may determine a foreign material light issue is detected in block 516. When the controller 902 determines a foreign material light 216 and foreign material heavy 218 issue in block 516, a determination may be made by the controller 902 whether the unthreshed grain 220 is greater than an unthreshed grain recent average, as in block 518. In some examples, the unthreshed grain recent average may be the unthreshed grain 220 detected over the previous period. When the unthreshed grain 220 is not greater than the unthreshed grain recent average in block 518, then the controller 902 may determine there is a foreign material light and a foreign material heavy issue in block 520. When the controller 902 only determines there is a foreign material light 216 and a foreign material heavy 218 issue in block 520, the grain quality method 400 may advance to block 512 and end.

Referring now to block 508, when the controller 902 determines unthreshed grain 220 is greater than the unthreshed grain recent average, the controller 902 may determine a foreign material light issue and an unthreshed grain issue in block 522. When the controller 902 determines there is a foreign material light issue and an unthreshed grain issue in block 522, the controller 902 may determine whether foreign material heavy 218 is greater than the foreign material heavy recent average in block 528. When the controller 902 determines foreign material heavy 218 is not greater than the foreign material heavy recent average in block 528, then the controller 902 may determine a foreign material light issue and an unthreshed grain issue in block 524. When the controller 902 determines there is a foreign material light issue and an unthreshed grain issue in block 524, then the grain quality method 400 may advance to block 512 and end. When the controller 902 determines the foreign material heavy 218 is greater than the foreign material heavy recent average in block 528, the controller 902 may determine there is a foreign material light issue, a foreign material heavy issue, and a unthreshed grain issue in block 526, the method 400 may advance to block 512 and end.

In FIG. 4, if the controller 902 determines foreign material heavy 218 is greater than unthreshed grain 220 in block 412, then the controller 902 may determine there is a foreign material heavy issue in block 602 of FIG. 6. When the controller 902 determines there is a foreign material heavy issue in block 602, the controller 902 may determine whether foreign material light 216 is greater than unthreshed grain 220 in block 604. When the controller 902 determines foreign material light 216 is greater than unthreshed grain 220 in block 604, then the controller 902 may determine whether foreign material light 216 is greater than a foreign material light recent average, as in block 606. In some examples, the foreign material light recent average may be the foreign material light 216 detected over a previous period.

According to some examples, the period may be based on the flowrate of harvested crop moving towards the grain tank 30. Each period may include a plurality of intervals, wherein each interval corresponds to an image captured by the grain quality sensor 920. In some examples, the controller 902 may calculate the recent average over a period, wherein the period includes, for example, 5 intervals, 10 intervals, 30 intervals, 100 intervals, or the like. According to some implementations, the plurality of intervals may be defined by software in the grain quality sensor 920. In other examples, the plurality of intervals may be time-based, and the grain quality sensor 920 may capture an image every 0.5 seconds, although other intervals less than every 0.5 seconds or greater than 0.5 seconds may be possible. When the controller 902 determines the foreign material light 216 is greater than the foreign material light recent average, then the controller 902 may determine that there is a foreign material light issue and a foreign material heavy issue as in block 608. However, in the instance when the controller 902 may determine the foreign material light 216 is not greater than the foreign material light recent average in block 606, then the controller 902 may determine that there is only a foreign material heavy issue in block 610. When the controller 902 determines there is only a foreign material heavy issue in block 610, the grain quality method 400 may advance to block 512 and end.

Referring to block 604, when the controller 902 determines the foreign material light 216 is not greater than the unthreshed grain 220, then a determination may be made by the controller 902 whether the unthreshed grain 220 is greater than the unthreshed grain recent average in block 614. In some instances, when the controller 902 determines that the unthreshed grain 220 is not greater than the unthreshed grain recent average in block 614, then the controller 902 may determine that there is only a foreign material heavy issue in block 616, and the grain quality method 400 may advance to block 612 and end.

Referring to block 608, when the controller 902 determines there is a light foreign material issue and a heavy foreign material issue, a determination may be made by the controller 902 whether unthreshed grain 220 is greater than the unthreshed grain recent average in block 618. When the controller 902 determines the unthreshed grain is not greater than the unthreshed grain recent average in block 618, then the controller 902 may determine that there is a foreign material light and a foreign material heavy issue in block 620, and the method 400 may advance to block 612 and end. In block 618, when the controller 902 determines the unthreshed grain 220 is greater than the unthreshed grain recent average, then the controller 902 may determine that there is a foreign material light issue, a foreign material heavy issue, and an unthreshed grain issue in block 622, and the method 400 may proceed to block 612 and end.

In block 614, if the controller 902 determines the unthreshed grain 220 is greater than the unthreshed grain recent average, then the controller 902 may determine that there is a foreign material heavy and an unthreshed grain issue in block 624. When heavy foreign material and unthreshed grain issues are detected by the controller 902 in block 624, a determination may be made by the controller 902 whether foreign material light 216 is greater than the foreign material light recent average in block 626. In some instances, when the controller 902 determines that the foreign material light is greater than the foreign material light recent average, then the controller 902 may determine that there is a foreign material light issue, a foreign material heavy issue, and an unthreshed grain issue in block 622, and the method 400 may proceed to block 612 and end. However, when the controller 902 determines the foreign material light is not greater than the foreign material light recent average in block 626, then the controller 902 may determine that there is a heavy foreign material issue and an unthreshed grain issue in block 628, and the grain quality method 400 may proceed to block 612 and end.

In FIG. 4, if the controller 902 determines that the foreign material heavy 218 is not greater than the unthreshed grain 220 in block 412, then the controller 902 may determine that there is an unthreshed grain issue in block 702 of FIG. 7. In some instances, when the controller 902 determines there is an unthreshed grain issue in block 702, a determination may be made by the controller 902 whether foreign material heavy 218 is greater than foreign material light 216 in block 704. When the controller 902 determines foreign material heavy 218 is greater than foreign material light 216 in block 704, then a determination may be made by the controller 902 whether foreign material heavy 218 is greater than the foreign material heavy recent average in block 706. In block 706, when the controller 902 determines the foreign material heavy 218 is greater than the foreign material heavy recent average, then the controller 902 may determine that there is an unthreshed grain issue and a heavy foreign material issue in block 708. When the controller 902 determines that the foreign material heavy 218 is not greater than the foreign material heavy recent average in block 706, then the controller 902 may determine that there is an unthreshed grain issue in block 710, and the grain quality method 400 may proceed to block 712 and end.

Referring to block 704, when the controller 902 determines the foreign material heavy 218 is not greater than foreign material light 216, then a determination may be made by the controller 902 whether foreign material light 216 is greater than the foreign material light recent average, as in block 714. When the controller 902 determines the foreign material light 216 is not greater than the foreign material light recent average, then the controller 902 may determine that there is an unthreshed grain issue in block 716, and the grain quality method 400 may advance to block 712 and end. When the controller 902 determines the foreign material light 216 is greater than the foreign material light recent average, then the controller may determine that there is a foreign material light issue and an unthreshed grain issue in block 718. When the controller determines that there is a foreign material light issue and an unthreshed grain issue in block 718, a determination may be made by the controller 902 whether the foreign material heavy 218 is greater than the foreign material heavy recent average, as in block 720. When the controller 902 determines the foreign material heavy 218 is not greater than the foreign material heavy recent average, then the controller 902 may determine that there is a foreign material light issue and an unthreshed grain issue in block 722. When the controller 902 determines that the foreign material heavy 218 is greater than the foreign material recent average in block 720, then the controller may determine that there is a foreign material light issue, a foreign material heavy issue, and an unthreshed grain issue in block 724, and the method 400 may proceed to block 712 and end.

Referring to block 708, when the controller 902 determines the unthreshed grain and heavy foreign material issues are detected, a determination may be made by the controller 902 whether foreign material light 216 is greater than the foreign material light recent average in block 726. When the controller 902 determines the foreign material light 216 is not greater than the foreign material light recent average in block 726, then the controller may determine that there is an unthreshed grain issue and a heavy foreign material issue in block 728, and the grain quality method 400 may advance to block 712 and end. When the controller 902 determines that the foreign material light 216 is greater than the light foreign material recent average in block 726, then the controller 902 may determine that there is a foreign material light issue, a foreign material heavy issue, and an unthreshed grain issue in block 724, and the grain quality method 400 may proceed to block 712 and end.

When one or more issues are detected by the controller 902 in the grain loss method 300 or the grain quality method 400, one or more of the machine settings 224 may be adjusted by the controller 902. In some examples, when the shoe loss issue, separator loss issue, or both the separator and shoe loss issues are detected by the controller, the rotor speed 226 or the threshing clearance 228 may be adjusted by the controller 902, among other settings. In one example, when the controller 902 detects one or more issues, the rotor speed 226, threshing clearance 228, fan speed 230, chaffer clearance 232, or sieve clearance 234 may be adjusted by the controller 902, among other settings. In some examples, the controller 902 may execute the grain quality method 400 and the controller 902 may detect one or more of the foreign material light, foreign material heavy, or unthreshed grain issue, and the fan speed 230, chaffer clearance 232, and/or sieve clearance 234 may be adjusted by the controller 902. In some examples, when the controller 902 detects one or more issues, the rotor speed 226, threshing clearance 228, fan speed 230, chaffer clearance 232, or sieve clearance 234 may be adjusted by the controller 902, among other settings. In some examples, the grain loss method 300 and the grain quality method 400 may be executed by the controller 902 simultaneously.

In some examples, each of the machine settings 224 may be prioritized by the controller 902, and when a grain loss system 208 issue is detected by the controller 902, the controller 902 may adjust the machine settings 224 via a first priority, and when a grain quality system 214 issue is detected by the controller 902, the machine settings 224 may be adjusted by the controller 902 via a second priority. In some examples, when one or more grain loss system 208 issues are detected by the controller after the controller 902 adjusts the first machine setting 224 in the first priority, the controller 902 may adjust the second machine setting 224 in the first priority, and the controller 902 may continue adjusting the machine settings 224 via the first priority until no issues are detected by the controller 902. Similarly, in some examples, when one or more grain quality system 214 issues are detected by the controller 902 after the controller 902 adjusts the first machine setting 224 in the second priority, the controller 902 may make an adjustment to the second machine setting 224 in the second priority, and the controller 902 may continue adjusting machine settings 224 via the second priority until no issues are detected by the controller 902.

In a first example, the first machine setting 224 in the first priority may be rotor speed 226, the second machine setting 224 in the first priority may be threshing clearance 228, the third machine setting 224 in the first priority may be fan speed 230, the fourth machine setting 224 in the first priority may be chaffer clearance 232, and the fifth machine setting 224 in the first priority may be sieve clearance 234. In this first example, one or more issues may be detected by the controller 902, and the rotor speed 226 may be adjusted by the controller 902. In some examples, when the rotor speed 226 is adjusted by the controller 902, the controller 902 may not detect any grain loss system 208 issues and no additional adjustments to the machine settings 224 may be made by the controller 902 at this time. In other examples, after the rotor speed 226 has been adjusted by the controller 902 one or more times, the controller 902 may still detect a grain loss system issue, and the second machine setting in the first priority, threshing clearance 228, may be adjusted by the controller. The controller 902 may continue adjusting the machine settings 224 in the first priority until no issues are detected by the controller 902.

In a second example, the controller 902 may adjust the machine settings via a second priority, and the order of the second priority may be, for example, fan speed 230, chaffer clearance 232, sieve clearance 234, threshing clearance 228, and rotor speed 226. In this example, one or more issues may be detected by the controller 902, and the fan speed 230 may be adjusted by the controller 902. In some examples, when the fan speed 230 is adjusted by the controller 902, the controller 902 may no longer detect grain quality system 214 issues and no additional adjustments to the machine settings 224 may be made by the controller 902 at this time. In other examples, after the fan speed 230 is adjusted by the controller 902 one or more times, the controller 902 may still detect a grain quality system issue, and the second machine setting in the second priority, chaffer clearance 232, may be adjusted one or more times by the controller 902. The controller 902 may continue adjusting the machine settings 224 in the second priority until the no issues are detected by the controller 902.

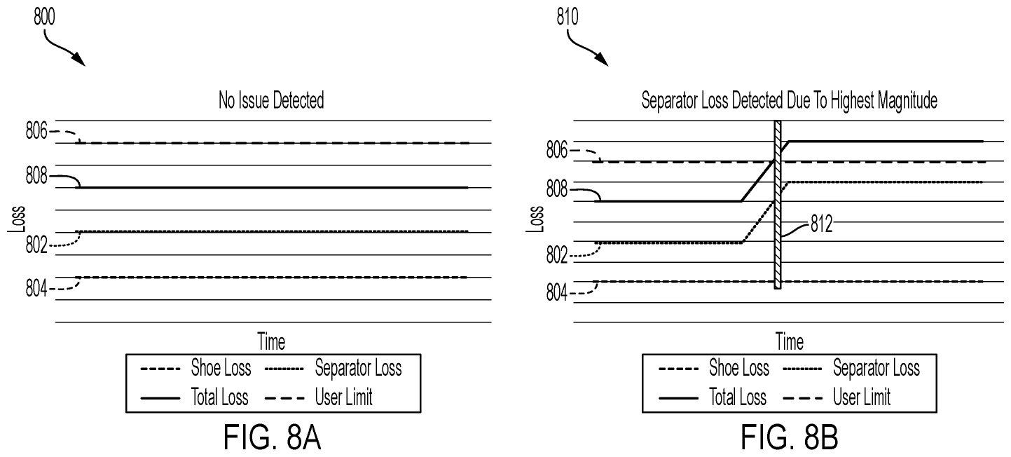

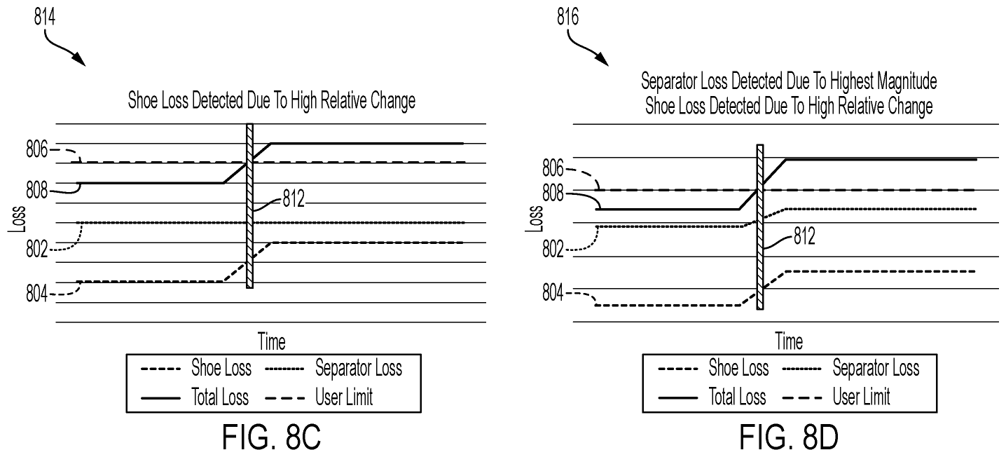

Referring now to FIG. 8a, one example of a graph with no issue detected 800 or determined by the controller 902 is illustrated wherein a y-axis is the amount of loss from the harvester 10 and an x-axis is time. The graph with no issue detected 800 may include separator loss 802, shoe loss 804, a user limit 806, and total loss 808. The total loss 808 may be the summation of the separator loss 802 and the shoe loss 804. In the example of FIG. 8a, the controller 902 may determine there is no issue because the total loss 808 is below the user limit 806.

Referring now to FIG. 8b, one example of a graph with a separator loss issue detected 810 or determined by the controller 902 is illustrated. Similar to FIG. 8a, FIG. 8b may include the y-axis, the x-axis, separator loss 802, shoe loss 804, the user limit 806, and total loss 808, wherein the total loss 808 may be the summation of the separator loss 802 and the shoe loss 804. In the graph with the separator loss issue detected 810, the shoe loss 804 may remain constant, or relatively constant over time. The separator loss 802 may include a period of time where the separator loss 802 increases. The total loss 808 may have a similar shape relative to the separator loss 802 because the total loss 808 may be the summation of the separator loss 802 and the shoe loss 804, and the shoe loss 804 may remain constant or relatively constant in the graph 810 whereas the separator loss 802 may change. The graph with a separator loss issue detected 810 may also include a line segment 812 that refers to the time when the total loss 808 surpasses the user limit 806. In the example of FIG. 8b, an issue may be detected or determined by the controller 902 because the total loss 808 surpasses the user limit 806. In other words, the issue is detected or determined by the controller 902 because the y-axis value for the total loss 808 is greater than the y-axis value for the user limit 806 on the graph 810. The controller 902 may attribute this loss to separator loss 802 because the separator loss 802 has the larger amount of loss when compared to the shoe loss 804 in FIG. 8b. Particularly, the issue detected in the graph 810 is attributed to separator loss 802 because at the time when the total loss 808 surpasses the user limit 806, and the time thereafter, the separator loss 802 is greater than shoe loss 804.

In some examples, rather than determining the issue based on the highest magnitude or amount of loss, as in FIG. 8b, the controller 902 determine the issue based on relative change of the separator loss 802 or relative change of the shoe loss 804, as in FIG. 8c. FIG. 8c illustrates a graph where a shoe loss issue is detected 814 or determined by the controller 902 due to a high relative change in shoe loss 804. As in FIG. 8b, FIG. 8c may include the y-axis, x-axis, separator loss 802, shoe loss 804, user limit 806, total loss 808, and the line segment 812 illustrating the time when the total loss 808 is greater than the user limit 806. In the graph with a shoe loss issue detected 810 or determined by the controller 902, the separator loss 802 may remain constant, or relatively constant over time. The shoe loss 804 may include a time period where the shoe loss 804 increases. The total loss 808 may have a similar shape as the shoe loss 804 because the total loss 808 may be the summation of the separator loss 802 and the shoe loss 804, and the separator loss 802 remains constant or relatively constant whereas the amount of shoe loss includes a time period where the amount of shoe loss 804 increases.

In some examples, the controller may determine issues using both the highest magnitude and relative change, as in FIG. 8d. FIG. 8d illustrates a graph where separator loss is detected and shoe loss is detected 816 or determined by the controller 902. Similar to FIG. 8b, FIG. 8d may include the y-axis, x-axis, separator loss 802, shoe loss 804, user limit 806, total loss 808, and the line segment 812 illustrating the time when the total loss 808 is greater than the user limit 806. In the graph where separator loss and shoe loss are detected 816 or determined by the controller 902, the separator loss 802 may include a time period where the separator loss 802 increases, and the shoe loss 804 may include a time period when the shoe loss 804 increases. As illustrated in FIG. 8d, the total loss 808 determined by the controller may include a time period where the total loss 808 increases a greater amount than the increase of the separator loss 802 individually and greater than the increase of the shoe loss 804 individually. This may occur because the increase in separator loss 802 and shoe loss 804 may increase in at least partially the same period of time, and total loss 808 may be the summation of the separator loss 802 and the shoe loss 804. In FIG. 8d, separator loss 802 may be detected or determined by the controller because the magnitude or amount of separator loss 802 may be greater than the magnitude or amount of shoe loss 804. A shoe loss 804 issue may also be detected or determined by the controller 902 in FIG. 8d because the shoe loss 804 exhibits a high relative increase in the amount of loss over a period of time.

FIG. 9 illustrates an example of a control system 900 in the harvester 10. The control system 900 may include a controller 904, one or more user inputs 908, one or more sensors 914, and a plurality of agricultural machine settings 922. The controller may include a memory unit 904 and may be microprocessor-based. The memory unit 904 may generally include instructions stored therein that are executable by a processor 906 of the controller 902 to control operation of the harvester 10. It will be understood, however, that this disclosure contemplates other implementations in which the controller 902 is not microprocessor-based, but is configured to control the operation of the harvester 10 based on one or more sets of hardwired instructions and/or software instructions stored in the memory unit 904.

The controller 902 may be coupled to the user inputs 908. The user inputs 908 may be similar to the user inputs 202 of FIG. 2, and the user inputs 908 may include a total loss limit 910, a total broken grain limit 911, and a total foreign material limit 912. The total loss limit 910 may include separator loss 210 and shoe loss 212, among others. The total broken grain limit 911 may include the broken grain 222, and the total foreign material limit 912 may include the amount of foreign material light 216, foreign material heavy 218, and unthreshed grain 220 in the grain tank 30 or otherwise with the clean grain. The user may initially input the user inputs 908 and may change the user inputs 908. In some examples, the user may enter user inputs 908, operate the harvester 10, perform a visual inspection, and may adjust the user inputs based 908 on the visual inspection. A visual inspection of the total broken grain limit 911 and total foreign material limit 912 may include a visual inspection of the grain tank 30, or an inspection via the grain quality sensor 920. A visual inspection of the total loss 910 may include a visual inspection of grain on the ground. After performing one or more inspection, the user may adjust the user inputs 908.

The controller 902 may also be coupled to one or more sensors 914. The one or more sensors 914 may include a separator loss sensor 916, a shoe loss sensor 918, and a grain quality sensor 920. In some examples, there may be one or more separator loss sensor 916, shoe loss sensor 918, and/or grain quality sensor 920. The separator sensor 916 may be a sensor that detects the amount of material lost due to separator loss 210, and the shoe loss sensor 918 may detect the amount of material lost due to shoe loss 212. The separator sensor 916 and shoe loss sensor 918 may communicate with the controller 902 the amount of loss detected.

The grain quality sensor 920 may be located in the grain tank 30, or may be mounted to the clean grain elevator which deposits grain from the harvester 10 to the grain tank 30. In some examples, the grain quality sensor 920 may be a camera, however other sensors are also considered herein. The grain quality sensor 920 may detect grain and other materials that are being delivered to the grain tank 30 via the grain elevator, or may detect grain and other materials that are already in the grain tank 30. In some examples, the grain quality sensor 920 may take an image of grain that is being delivered to the grain tank 30 via the grain elevator, may communicate the image to the controller 902, and the controller may analyze the image and classify material in the image as foreign material light 216, foreign material heavy 218, unthreshed grain 220, and/or broken grain 222, among others. In some examples, the grain quality sensor 920 may capture a plurality of images in one or more intervals. The intervals may be defined by software included in the grain quality sensor 920. In some examples, the one or more intervals may be based on the flowrate of harvested crop moving towards the grain tank 30. In some examples, the grain quality sensor 920 may be a camera that captures an image based upon a time interval such as, for example, every 0.5 seconds, although the intervals may be less than every 0.5 seconds or greater than 0.5.

The agricultural machine setting 922 may also be coupled to the controller 902, and the agricultural machine settings 922 may be similar to the machine settings 224 of FIG. 2. For example, the machine settings 922 may include rotor speed 924, threshing clearance 926, fan speed 928, chaffer clearance 930, and sieve clearance 932, among others. In some examples, when the controller 902 determines that the sensors 914 detect amounts of loss, broken grain, and/or foreign material that is greater than the user inputs 908, the controller 912 may adjust one or more of the agricultural machine settings 922. As also described in FIG. 2, when the issue detected is associated with the loss limit 910, the controller 902 may adjust the agricultural machine settings 922 via a first priority, and when the issue detected is associated with the total broken grain limit 911 and/or the foreign material limit 912, the controller 902 may adjust the agricultural machine settings 922 via a second priority.

Referring now to FIG. 10, one implementation of a broken grain method 1000 is illustrated. The broken grain method 1000 may be executed to determine when there is excessive broken grain in the grain tank or otherwise with the clean grain. The broke grain method may begin with block 1002, where the controller 902 may calculate total broken grain as the total amount of broken grain, as in block 1004. In block 1006, a determination may be made by the controller 902 whether the total broken grain determined by the controller 902 is greater than an acceptability threshold or limit of total broken grain input by the user or operator of the harvester 10. When the controller 902 determines that the total broken grain is not greater than the total broken grain input by the user or operator of the harvester 10 in block 1006, the method 1000 may return to block 1004 and the controller 902 may calculate the total broken grain as the total amount of broken grain. When the controller determines that the total broken grain is greater than the total broken grain acceptability threshold or limit input by the user or operator of the harvester 10 in block 1006, the controller may determine that there is a total broken grain issue in block 1008, and the broken grain method 1000 may advance to block 1010 and end.

In this application, including the definitions below, the term “module” or the term “controller” may be replaced with the term “circuit.” The term “controller” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 122(f) unless an element is expressly recited using the phrase “means for,” or in the case of a method claim using the phrases “operation for” or “step for.”

While exemplary implementations incorporating the principles of the present disclosure have been described herein, the present disclosure is not limited to such implementations. Instead, this application is intended to cover any variations, uses, or adaptations of the disclosure using its general principles. Further, this application is intended to cover such departures from the present disclosure as come within known or customary practice in the art to which this disclosure pertains.

1. An agricultural machine configured to perform a harvesting operation, comprising:
a chassis;
a header coupled to the chassis, the header configured to harvest a crop during the harvesting operation in a field;
a separating section of the agricultural machine configured to separate grain from the harvested crop;
a cleaning shoe of the agricultural machine configured to clean the grain received from the separating section and move the grain towards a tank coupled to the chassis, wherein the separating section and cleaning shoe are positioned downstream from the header and upstream from the tank;
a sensor configured to detect a quantity of grain loss from the agricultural machine during the harvesting operation or a quality of the grain; and
a control system comprising a controller disposed in communication with the sensor, the controller configured to store a first threshold related to a quantity of grain loss and a second threshold related to a grain quality;
wherein the controller is configured to receive a signal from the sensor, the signal corresponding to the quantity of grain loss or the quality of the grain;
wherein the controller is configured to compare the signal from the sensor to either the first threshold or the second threshold and determine if the quantity of grain loss exceeds the first threshold in response to the comparison of the signal from the sensor to the first threshold or the quality of the grain exceeds the second threshold in response to the comparison of the signal from the sensor to the second threshold.

2. The agricultural machine of claim 1, wherein the sensor comprises a plurality of sensors, wherein one of the plurality of sensors detects the quantity of grain loss from the separating section, the cleaning shoe, or the header.

3. The agricultural machine of claim 1, wherein the sensor comprises a plurality of sensors, where one of the plurality of sensors detects the quality of the grain in a tank or an elevator coupled to the chassis.

4. The agricultural machine of claim 1, wherein the sensor comprises a camera.

5. The agricultural machine of claim 2, wherein the sensor is configured to capture an image of the grain when detecting the quality of the grain, the controller receiving the image from the sensor via the signal and being configured to analyze the quality of the grain from the image.

6. The agricultural machine of claim 1, wherein the controller is configured to adjust a machine setting in response to the grain loss exceeding the first threshold or in response to the quality of the grain exceeding the second threshold.

7. The agricultural machine of claim 1, wherein:
the sensor is configured to detect the quantity of grain loss, the quality of the grain, or a quantity of broken grain during the harvesting operation;
the controller is configured to store a third threshold related to broken grain; and
wherein, when the sensor detects the quantity of broken grain during the harvesting operation, the sensor is configured to communicate the signal corresponding to the quantity of broken grain to the controller, and the controller is configured to compare the quantity of broken grain to the third threshold.

8. The agricultural machine of claim 6, wherein the machine setting includes one or more of rotor speed, threshing clearance, fan speed, chaffer clearance, and sieve clearance.

9. The agricultural machine of claim 6, wherein the controller comprises a plurality of controllers, where a first controller of the plurality of controllers is in communication with the sensor and is configured to receive the signal from the sensor and compare the signal from the sensor to the first threshold or second threshold;
wherein a second controller of the plurality of controllers is communicatively coupled to the first controller, the second controller configured to adjust one or more machine settings based on the comparison of the signal to the first threshold or second threshold.

10. The agricultural machine of claim 6, wherein:
the machine setting comprises at least a first machine setting and a second machine setting;
after the controller adjusts the first machine setting, the controller is configured to detect the quantity of grain loss or quality of grain, and, if the controller determines that the quantity of grain loss exceeds the first threshold in response to the comparison of the signal from the sensor to the first threshold or the quality of the grain exceeds the second threshold in response to the comparison of the signal from the sensor to the second threshold, the controller is configured to operably adjust the second machine setting.

11. The agricultural machine of claim 1, wherein:
the sensor is configured to detect the quantity of grain loss from one or more of the cleaning shoe, the separating section, and the header;
the sensor is configured to communicate the quantity of grain loss from the one or more of the cleaning shoe, the separating section, and the header to the controller;
wherein the controller is configured to determine a total quantity of grain loss based on the quantity of grain loss detected by the sensor from the one or more of the cleaning shoe, the separator, and the header.

12. The agricultural machine of claim 1, wherein the sensor is configured to detect one or more of foreign material, unthreshed grain, or broken grain when detecting the quality of the grain,
wherein the sensor is configured to communicate the signal regarding the quality of the grain to the controller, the signal regarding the quality of grain including information about the foreign material, unthreshed grain, or broken grain detected by the sensor, and
wherein the controller is configured to determine the quality of the grain based on the information about the foreign material, unthreshed grain, or broken grain.

13. A control system for an agricultural machine configured to perform a harvesting operation to harvest a crop, comprising:
a controller configured to store a first threshold or a second threshold, the first threshold related to a quantity of grain loss by the agricultural machine during the harvesting operation and the second threshold related to a quality of grain harvested during the harvesting operation, and
a sensor disposed in communication with the controller, the sensor configured to detect the quantity of grain loss or the quality of the grain during the harvesting operation,
wherein, during the harvesting operation, the sensor is configured to send a signal to the controller corresponding to the quantity of grain loss or the quality of the grain, and
wherein the controller is configured to compare the signal from the sensor to either the first threshold or the second threshold and determine whether the quantity of grain loss exceeds the first threshold in response to the comparison between the signal from the sensor and the first threshold or the quality of the grain exceeds the second threshold in response to the comparison between the signal from the sensor and the second threshold.

14. The control system of claim 13, wherein the controller is configured to adjust a machine setting when the quantity of grain loss exceeds the first threshold or when the quality of the grain exceeds the second threshold.

15. The control system of claim 14, wherein the machine setting comprises a rotor speed, a threshing clearance, a fan speed, a chaffer clearance, or a sieve clearance.

16. The control system of claim 13, wherein the sensor comprises a plurality of sensors, where a first sensor of the plurality of sensors is configured to detect the quantity of grain loss and a second sensor of the plurality of sensors is configured to detect the quality of the grain.

17. The control system of claim 13, wherein the controller is configured to receive an input corresponding to the first threshold or the second threshold from an input device, the input received by the controller including a value based on a linear numeric scale or a percentage.

18. A method for adjusting a machine setting in a work machine configured to perform a harvesting operation to harvest a crop, the method comprising:
providing a control system including a controller and a sensor;
receiving by the controller a plurality of thresholds including a first threshold corresponding to a quantity of grain loss during the harvesting operation and a second threshold corresponding to an amount of foreign material;
detecting by the sensor during the harvesting operation a quantity of grain loss or a quality of grain;
comparing, by the controller, the quantity of grain loss to the first threshold or the quality of grain to the second threshold;
identifying, by the controller, a grain loss issue in response to the quantity of grain loss being greater than the first threshold or a grain quality issue in response to the quality of grain being greater than the second threshold; and
adjusting a setting on the work machine when the controller identifies a grain loss issue or a grain quality issue.

19. The method of claim 18, further comprising:
when a grain loss issue or a grain quality issue is identified, comparing a first subcategory to at least a second subcategory of a plurality of subcategories, where each of the plurality of subcategories is related to either the grain loss issue or the grain quality issue identified by the controller; and
determining, by the controller, the first subcategory contributes to the grain loss issue or the grain quality issue more than the second subcategory when a magnitude of the first subcategory is greater in comparison to a magnitude of the second subcategory, and the second subcategory contributes to the grain loss issue or the grain quality issue more than the first subcategory when the magnitude of the second subcategory is greater in comparison to the magnitude of the first subcategory.

20. The method of claim 18, further comprising:
when a grain loss issue or a grain quality issue is identified, comparing a first subcategory to at least a second subcategory of a plurality of subcategories, where each of the plurality of subcategories is related to either the grain loss issue or grain quality issue identified by the controller;
determining, by the controller, the first subcategory contributes to the grain loss issue or the grain quality issue more than the second subcategory when the first subcategory changes more over a predetermined period of time in comparison to the second subcategory, and the second subcategory contributes to the grain loss issue or the grain quality issue more than the first subcategory when the second subcategory changes more over the predetermined period of time in comparison to the first subcategory.
